(19) United States
(12) Patent Application Publication
(10) Pub. No.: US 2017/0050481 A1
(43) Pub. Date: Feb. 23, 2017

(54) Adjustable Trailer Connection

(71) Applicants: Joseph Anthony Bidwell, Maple Ridge (CA); Jeromy Andrew Hewitt, Pitt Madows (CA)

(72) Inventors: Joseph Anthony Bidwell, Maple Ridge (CA); Jeromy Andrew Hewitt, Pitt Madows (CA)

(21) Appl. No.: 15/193,030

(22) Filed: Jun. 25, 2016

Related U.S. Application Data
(60) Provisional application No. 62/184,660, filed on Jun. 25, 2015.

(51) Int. Cl. B60D 1/46; B60D 1/52; B60D 1/54; B60D 1/06; B60D 1/24

(52) U.S. Cl. CPC B60D 1/465; B60D 1/06; B60D 1/246; B60D 1/54; B60D 1/52; B60D 2001/548

(57) ABSTRACT

The invention is an extendable, retractable and swiveling arm of the Cobra Hitch that can easily attaches a vehicle to its trailer, without the stressful task of lining up the tow ball with the trailer tongue. The arm is extendable and retractable, swivels left and right and can be manual or remote control operated. An improved hitch is provided for connecting a truck and trailer through a hitch arm which is adjustable in length and, and retractable once engaged to bring the truck and trailer into a position suitable for towing.

### CROSS-REFERENCES TO RELATED APPLICATIONS (IF ANY)

This application claims the priority date of Provisional Application No. 62/184,660 filed on Jun. 25, 2015.

### BACKGROUND

1. Field of the Invention

The invention relates to a trailer connection in more particular a connection that is extractable and retractable.

2. Description of Prior Art

The hitches to be used with and connected to trailers are normally fixed and can be hard to properly move to attach to a vehicle. They also increase the length of the trailer and make it harder to secure and store the trailer.

There is still room for improvement in the art.

### SUMMARY OF THE INVENTION

The present invention is an extendable, retractable and swiveling arm of a Cobra Hitch that can easily attaches a vehicle to its trailer without the stressful task of lining up the tow ball with the trailer tongue.

The arm is extendable and retractable, swivels left and right and can be manual or remote control operated. These are improved designs and methods for connecting a towing load with a towing vehicle. In one embodiment an improved hitch is provided for connecting a vehicle and trailer through a hitch arm which is adjustable in length and, and retractable once engaged to bring the vehicle and trailer into a position suitable for towing.

The current invention is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows a partially transparent side view of an improved hitch in keeping with one embodiment of the present invention;

FIG. 2 display a partially transparent side view of an improved hitch in keeping with another embodiment of the present invention;

FIG. 3 displays a partially transparent side of view of an improved hitch in keeping with another embodiment of the present invention connected with a trailer; and

FIG. 4 shows a partially transparent overhead view of an improved hitch in keeping with another embodiment of this invention when installed within or on a hidden hitch of a truck.

### DESCRIPTION OF THE PREFERRED EMBODIMENT

There are a number of significant design features and improvements incorporated within the invention.

The current invention is an improved trailer hitch mounted to a trailer, or other object intended to be towed. In accordance with some of the other disclosed embodiments here is provided an improved trailer hitch mounted to a vehicle or other towing source.

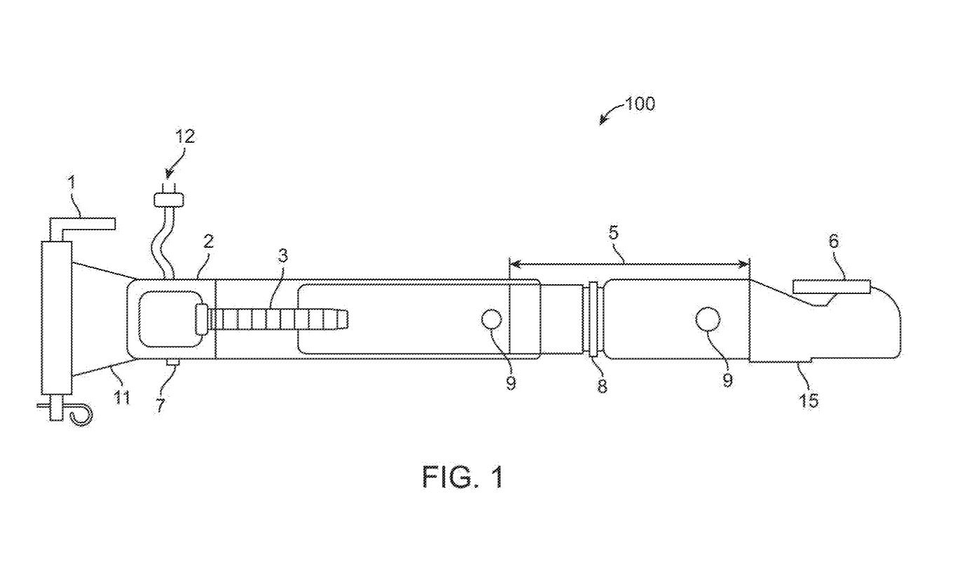

One embodiment of the hitch 100 is shown in FIG. 1. In this embodiment, a pin 1 is attached to affix the hitch body 11 to a trailer or other device. This is a reversibly attachment. Any locking mechanisms could be used, such as bolts or screws. The hitch 100 could also be permanently affixed, or manufactured as part of the trailer, such as a continuation of the trailer frame.

A movement means like a Motor 2, which can be located on the trailer, on the hitch 100, or as shown in FIG. 1 enclosed within the hitch body 11. A variety of motor types can be used, suitable for the weight of the trailer and load. In one embodiment, the motor is a 12 volt electrical motor 2 operated by a toggle switch. The power source could be an external plug 12, or connected to a power source or other motor on the trailer or vehicle, such as the battery of a vehicle. Suitable electrical connections between the trailer and the vehicle can also optionally be enclosed or partially enclosed within the hitch 100. The hitch 100 may also include guides, clips, or the like to assist with the electrical connections and for storage of same, such as retractable extension cords with a covered storage area.

The hitch 100, in the preferred embodiment, would have a mechanical backup 7 that can be used as a movement means such as a backup stud for use with a hand crank, which can optionally be included to provide for mechanical force in the absence of motor functionality or power source. In some embodiments the hitch 100 could be provided without a motor 2, and only the mechanical backup would be provided, and in other embodiments neither the motor 2 nor the mechanical backup 7 would be provided.

Mechanical backup 7 while shown as a backup stud can be other means for mechanically shortening or extending the length of the hitch, such as a jack, winch, or lever arm. The hitch 100 may optionally contain the mechanical backup 7 partially or fully within the hitch 100, can have a location for a component of the mechanical backup to be stored, or otherwise.

In the hitch 100, an extraction/retraction means 3 such as a threaded rod or other mechanism such as a rope or chain is provided to utilize the force from the motor 22 and/or mechanical backup 7 to retract or extend the further the hitch 100. In one embodiment the hitch 100 can be extended manually, with or without a mechanical backup 7, and then can be retracted once engaged through the use of the motor 2. In the embodiment shown in FIG. 1 the hitch body 11 has an outer casing 4, which contains the motor 2, and which can contain a portion of the outer arm 5 portion of the hitch 100 slides into when it is retracted by threaded rod 3.

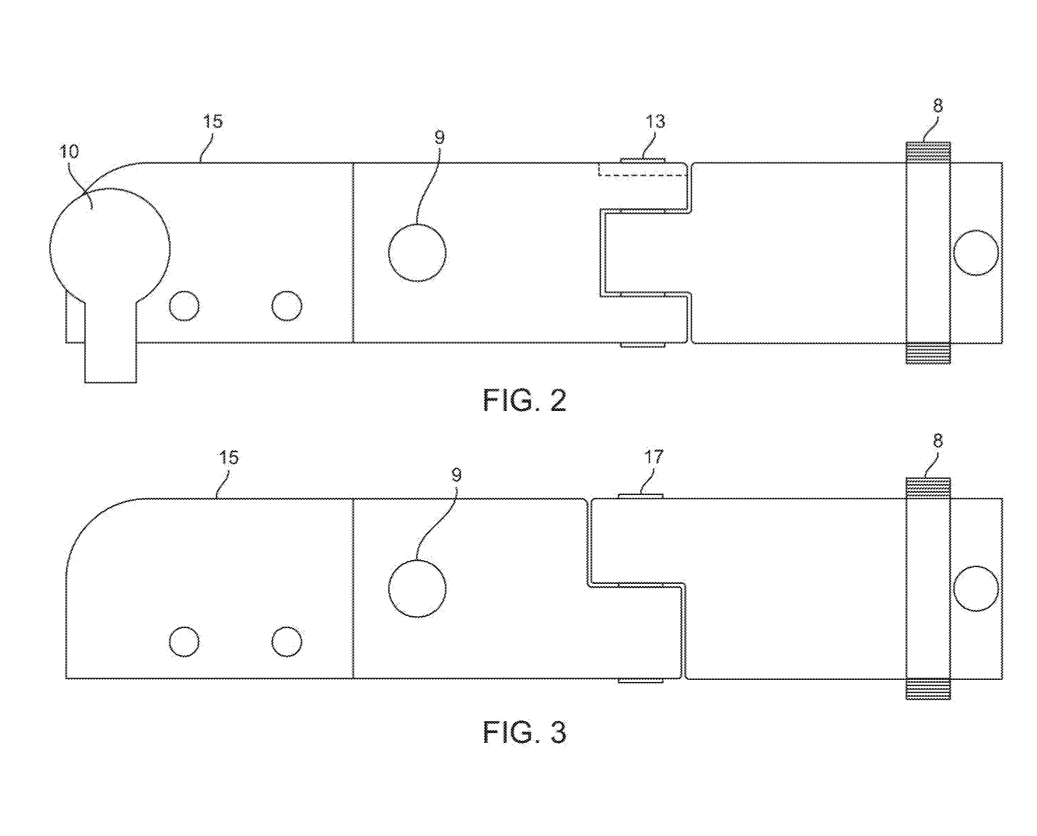

The extraction/retraction means 3 is connected to the movement means and connected to the arm 5 of the hitch 100. Using the movement means like a motor 2, the extraction/retraction means 3 moves/pulls/releases the arm 5. The arm 5 moves within the outer casing 4 and extending beyond the outer casing 4 when needed. The end of the arm 5 will have the ball socket 6 which is connected to the tow ball 10 of the vehicle as shown in FIG. 2.

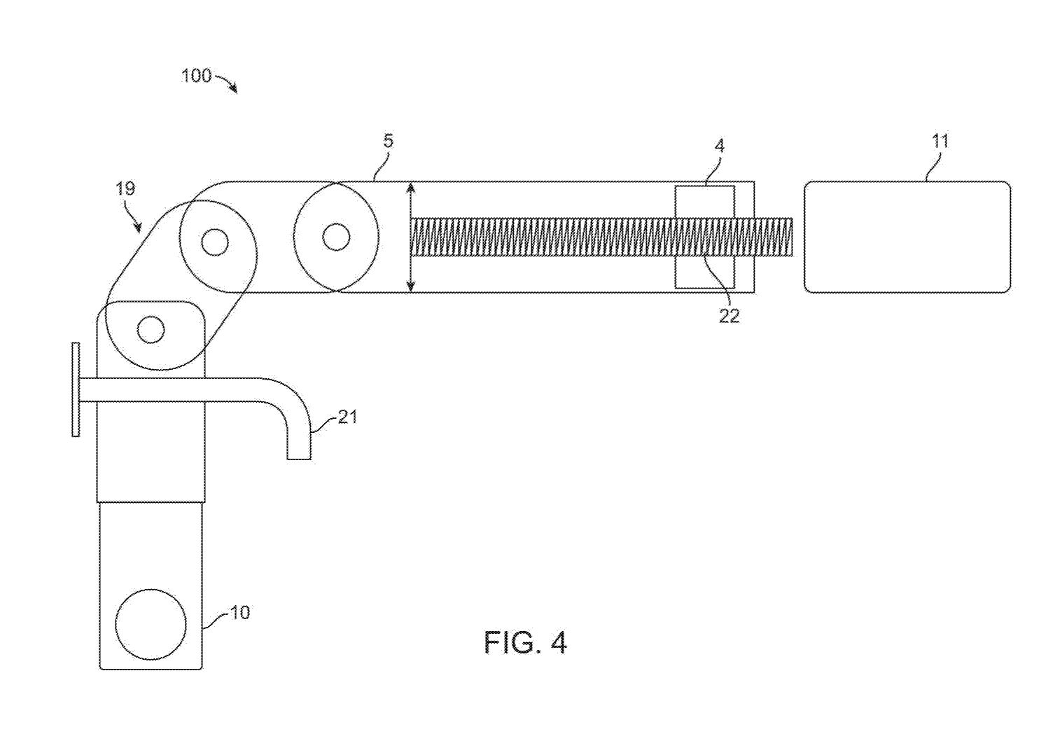

The arm 5 can have a hinge point 8, which allows for a portion of the hinge arm 15 to be rotated along at least one dimension. In the embodiment shown in FIG. 1 the hinge 8 is at an outer portion of the arm 5 and the rotation is along the horizontal plane. It will be appreciated various locations for the hinge 8 could be provided, such as in conjunction with pin 1, or including within the body, which may require the movement means 3 to be a flexible component such as a chain or rope. The hinge component 8 could also be more than one hinge, to allow snaking or flexibility along multiple points as shown in FIG. 4, and, or to allow rotation in more than one plane. In another variant the rotation provided by hinge 8 might optionally be provided by a non-hinge means, such as replacing a portion of the hitch arm 5 with a sufficiently strong and flexible or reversibly deformable material, such as a series of interlinked chain, rope, or the like.

In some embodiments the trailer hitch 100 is collapsible or partially collapsible for storage purposes, such as to reduce the total length of the trailer with hitch to allow the trailer to be stored in a garage or the like. In one method of collapsing the trailer hitch hinge 8 allows for substantially rotation, such as to collapse the outer part of the arm towards the base of the arm. In another method a hinge is located closer to the base of the arm 5, such as near pin 1. In a further aspect of this variation the pin 1 has two engaged modes that maintain a connection between the trailer and the trailer hitch 100; in the first mode the pin 1 is positioned so as to it allows rotation from a stored to an extended position when the trailer is going to be towed, and from the extended position to a stowed position when the trailer is being stored, in the second mode the trailer hitch 100 is locked at the base by pin 1 so as to facilitate towing.

At the outer length of the arm of the hitch 100 shown in FIG. 1 is a pin hole set 9, one of two sets of pin holes are shown. When the arm 5 is fully retraced the two sets of pin holes would line up, with the pin hole set 9 being within the pin hole set found on outer casing 4, such that a rod 1 can be inserted to lock the arm 5 in the retracted position. Locking may not be required for towing or all operations, but would provide safety advantages in some situations and may be required by regulations.

FIGS. 2 and 3 shows two embodiments where a hitch 100 contains additional hinges 13 and 17 in the arm 5, which allows for the folding of the hitch for storage when not in use. The use of a folding hinge (13, 17) is particularly suitable when the extension or retraction mechanism is either flexible at the same point as the hinge, such as a rope or chain, or is located past the hinge 8 along the length of the arm 5.

It is noted that while various embodiments have been described with respect to the trailer hitch 100 being affixed or reversibly affixed to a trailer and facilitating hitching to the towing vehicle the teachings of the present disclosure are applicable to the situation of the trailer hitch being affixed to the towing vehicle, and being used to hitch to the trailer. In one example a variation of a hidden hitch as found on certain trucks can be utilized. In a particular embodiment pin 1 of FIG. 1 could be replaced by incorporating the structure as part of the vehicle frame, motor 2 of FIG. 1 could be incorporated above the hidden hitch and might conveniently be powered by the vehicle's engine either through electrical or mechanical means, (or alternatively solely mechanical means could be utilized, such as a ratcheting system to capture energy from the vehicles wheel rotation or forward momentum), could to hold out of view the motor 2 and threaded rod 3 of FIG. 1 could be replaced with a chain or hook.

In one further variant the hinge 8 could be combined with a pin 1 or the like, to allow the outer arm 15 to be detachable and removable for storage, or for separate sale as an accessory.

Another variant is shown in FIG. 4, where a motor 2 and connecting means 3 such as a threaded rod 22 are securely placed along or within the frame of a vehicle with a hidden hitch, along with a chain or rope or similar mechanism to facilitate lengthening or retracting the length of the hitch. A pin 21 or other device is optionally employed to secure the exterior portion of the hitch 100 to the vehicle. Pulley wheels 19 or other mechanisms are in some embodiments employed to safely transmit motive power through the hitch 100 to extend, or retract, or both extend and retract, the hitch 100, and will be functionally connected to the motor 2, through the threaded rod 22 via the chain or rope.

While the invention has been disclosed according to various embodiments, various other methods are envisioned, including multiple pin holes to allow for locking at different lengths, other locking mechanisms, such as a pin hole on movement means 3 like a threaded rod and a corresponding hole above the movement means 3 on outer casing 4 to lock the movement means 3 in place.

In this description, references to “one embodiment” mean that the feature being referred to may be included in at least one embodiment of the invention. Moreover, separate references to “one embodiment” or “some embodiments” in this description do not necessarily refer to the same embodiment.

The invention may include any variety of combinations and/or integrations of the features of the embodiments described herein. Although some embodiments may depict serial operations, the embodiments may perform certain operations in parallel and/or in different orders from those depicted. Moreover, the use of repeated reference numerals and/or letters in the text and/or drawings is for the purpose of simplicity and clarity and does not in itself dictate a relationship between the various embodiments and/or configurations discussed. The embodiments are not limited in their applications to the details of the order or sequence of steps of operation of methods, or to details of implementation of devices, set in the description, drawings, or examples. Moreover, individual blocks illustrated in the figures may be functional in nature and do not necessarily correspond to discrete hardware elements.

While the methods disclosed herein have been described and shown with reference to particular steps performed in a particular order, it is understood that these steps may be combined, sub-divided, or reordered to form an equivalent method without departing from the teachings of the embodiments. Accordingly, unless specifically indicated herein, the order and grouping of the steps is not a limitation of the embodiments. Furthermore, methods and mechanisms of the embodiments will sometimes be described in singular form for clarity. However, some embodiments may include multiple iterations of a method or multiple instantiations of a mechanism unless noted otherwise. For example, when a connection is disclosed in one embodiment, the scope of the embodiment is intended to also cover the use of multiple connections. Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination. Embodiments described in conjunction with specific examples are presented by way of example, and not limitation. Moreover, it is evident that many alternatives, modifications, and variations will be apparent to those skilled in the art. It is to be understood that other embodiments may be utilized and structural changes may be made without departing from the scope of the embodiments.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A hitch comprising:
a body with an outside casing, a movement means connected to an extraction/retraction means that is connected an arm where the arm has a hinge.

2. A hitch according to claim 1 comprising:
having the movement means be a motor.

3. A hitch according to claim 1 comprising:
having the movement means be mechanical.

4. A hitch according to claim 3 comprising:
where the movement means is one of a set of a jack, winch, or lever arm.

5. A hitch according to claim 1 comprising:
where the hinge turns on a horizontal axis.

6. A hitch according to claim 1 comprising:
where the arm moves within the outer casing and can extends beyond the outer casing.

7. A hitch according to claim 1 comprising:
having said connecting means be a threaded rod.

8. A hitch according to claim 1 comprising:
having said hitch be collapsible.

9. A hitch according to claim 8 comprising:
having an additional hinge in the arm.

10. A hitch according to claim 1 comprising:
where the arm is detachable.

11. A process to extract/retract a hitch comprising:
having a hitch with a body with an outside casing, a movement means connected to an extraction/retraction means that is connected an arm where the arm has a hinge; and
using the movement means to move the extraction/retraction means; and
having the extraction/retraction means pull or release the arm.

12. A process according to claim 11 comprising:
having the movement means be a motor.

13. A process according to claim 11 comprising:
having the movement means be mechanical.

14. A process according to claim 13 comprising:
where the movement means is one of a set of a jack, winch, or lever arm.

15. A process according to claim 11 comprising:
where the hinge turns on a horizontal axis.

16. A process according to claim 11 comprising:
moving the arm within the outer casing.

17. A process according to claim 11 comprising:
having said connecting means be a threaded rod.

18. A process according to claim 1 comprising:
having said hitch be collapsible.

19. A process according to claim 18 comprising:
having an additional hinge in the arm, and
folding the arm on the additional hinge for storage.

20. A process according to claim 11 comprising:
having the arm be detachable.
